(19) United States
(12) Patent Application Publication
(10) Pub. No.: US 2026/0308455 A1
(43) Pub. Date: Oct. 8, 2026

(54) METHOD FOR CONVERTING PLASTIC INTO HYDROCARBON(S)

(71) Applicants: INSTITUT NATIONAL DES SCIENCES APPLIQUÉES DE TOULOUSE, Toulouse Cedex 4 (FR); CENTRE NATIONAL DE LA RECHERCHE SCIENTIFIQUE, Paris (FR); UNIVERSITE TOULOUSE III - PAUL SABATIER, Toulouse Cedex 9 (FR)

(72) Inventors: Bruno CHAUDRET, Toulouse Cedex 4 (FR); Sourav GHOSH, Toulouse Cedex 4 (FR); Thibault OURLIN, Toulouse Cedex 4 (FR)

(21) Appl. No.: 19/481,951

(22) PCT Filed: May 7, 2024
(86) PCT No.: PCT/EP2024/062590

§ 371 Date: Nov. 6, 2025

(30) Foreign Application Priority Data
May 10, 2023 (FR) FR2304642

(51) Int. Cl. C10G 1/10

(52) U.S. Cl. CPC C10G 1/10; C10G 2300/1003; C10G 2300/70

(57) ABSTRACT

A method for converting a solid or liquid substrate selected among substrates formed of plastics material and heavy oils, into hydrocarbon(s) by a conversion reaction of hydrogenolysis and/or pyrolysis, occurring in a given temperature range. This method comprises contacting, in a reactor, the substrate and a microscale heating element formed of a ferromagnetic metal compound, under an oxygen-free atmosphere, and heating this heating element, at a temperature within said temperature range, by electromagnetic induction via a magnetic field inductor external to the reactor.

The present invention lies in the general field of recycling of plastic materials.

More particularly, the present invention relates to a method for transforming, into hydrocarbon(s), a substrate made of plastic material or a heavy oil, using the technique of heating by electromagnetic induction. The invention also relates to the use, for such a transformation, of a micrometric heating element formed of a ferromagnetic metal compound.

Plastic waste, a major cause of pollution in landfills and oceans, is a source of global concern, mainly due to the enormous production rate and long lifetime of the materials that form it. As an example, the worldwide production capacity for polyethylene, the category of plastics most widely used, in highly varied fields ranging from trash bags to bubble wrap and hip prostheses, is 80 million tons per year. Polyethylene molecules are, as indicated by their name, composed of several ethylene molecules (C₂H₄). The chains of polyethylene can be linear or branched, their degree of branching affecting the rigidity, the density and the strength of the material. In general, the polyethylene produced is chemically inert and resistant to decomposition. It accounts for approximately 60% of the plastics found in landfills, where it decomposes very slowly, if decomposition even takes place.

Several types of plastic recycling sectors have been developed and are constantly improved to cope with the enormous amount of plastic waste generated by industry. Mechanical recycling currently processes collected plastic waste efficiently, it has very good yields and is well established in the sorting sector. However, it has several limits. On the one hand, it is not suitable for separating the polymers of the plastic components from their additives, for example colorants. On the other hand, although the sector is advancing at a rapid pace, the physical characteristics of the material coming from the recycling are often degraded relative to the original material. The recycled plastic is thus still often used for uses other than its initial use, in particular in the construction and building sector. The combination of these factors limits the scale at which plastic is recycled, especially since it is still often less costly to use virgin raw materials to produce items made of plastic.

To take a step towards a circular economy, it is necessary to process the share of the collected plastics that mechanical recycling is unable to handle satisfactorily.

Several chemical recycling techniques, distinct in their method and the structure of the end product obtained, have been proposed in order to complement mechanical recycling and avoid resorting to incineration or landfilling. Examples of these techniques include:
dissolution, which allows to recover, using a solvent, the polymer chains, usable to form new plastics,
chemical depolymerization, allowing to return to the stage of the monomers by the use of a chemical solvent; these monomers can subsequently be used to form new polymer chains,
biochemical conversion, which corresponds to a chemical depolymerization in which the chemical agents are replaced by enzymes,
pyrolysis or gasification, that is to say thermal depolymerization, which allows to recover hydrocarbons in the liquid state and/or in the gaseous state, according to their chain length, via heat treatment methods. Reinjected into a steam cracker, part of these hydrocarbons make it possible to form new plastics, by thermal cracking, catalytic cracking or hydrocracking, in the presence of catalyst and hydrogen.

The transformation of plastic into fuel by pyrolysis has in particular been a known and industrially developed method for more than ten years. However, this method is energy-consuming and it does not allow to control the selectivity of the products formed.

The document US 2022/055902 for example describes the transformation of thermoplastic polymers into short-chain C6-C10 hydrocarbons, by pyrolysis in a furnace at high temperature, the hydrocarbons obtained then being treated by heating by magnetic induction, in the presence of large heating elements such as rods or plates, to form carbon nanotubes.

In general, the methods for recycling plastic materials proposed by the prior art are expensive to implement and energy-consuming, and/or they produce low-quality compounds that are difficult to use. Furthermore, their effectiveness can be limited to certain plastics. For example, biochemical conversion, while effective for recycling polyethylene terephthalate, is much less so for the most commonly used plastics, namely polyethylene and polypropylene.

The document WO 2023/064741 describes a method for depolymerizing plastics using radiofrequency induction heating, implementing a catalyst and a magnetic susceptor in the form of nanoparticles of Fe₃O₄, having a size between 50 and 100 nm. This method allows to depolymerize plastics into C2-C20 alkanes and alkenes.

The document US 2013/303810 describes a method for depolymerizing a substrate made of plastic material such as a polyolefin, into materials with a lower boiling point. This method comprises a step of heating the substrate by magnetic induction using steel balls.

The present invention aims to overcome the drawbacks of the methods proposed by the prior art for recycling waste made of plastic materials, in particular the drawbacks disclosed above, by proposing such a method that allows to produce compounds with a high added value, and in particular methane, preferably with high yield and high specificity, in a manner that is economical and in particular consumes little energy.

It has now been discovered by the present inventors that such results can be achieved by a method implementing an electromagnetic induction heating mode, in the presence of a micrometer-sized heating element mixed with the substrate made of plastic material to be transformed. Such a method uses particularly little energy and has great versatility, in the sense that it allows, by the choice of suitable operating conditions, to orient the transformation of the plastic materials into various targeted reaction products, in particular into hydrocarbon(s) with a longer or shorter chain. Surprisingly, the present inventors have in particular discovered that the implementation of such a method according to specific operating conditions further makes it possible to form methane with controlled selectivity, and in particular as the largely majority product of the reaction, with high yield, including in the absence of compounds catalyzing the reaction of transformation of the plastic material, and/or when the heating element is simple iron wool.

Thus, according to the present invention, a method is proposed for transforming into hydrocarbon(s) a solid or liquid substrate chosen from the substrates formed of plastic material(s) and the heavy oils, by a transformation reaction occurring in a given temperature range. This method comprises steps of:
in a reactor, contacting this substrate and an element, called heating element, in micrometric form, that is to say in the form of entity(ies) all the dimensions of which are greater than or equal to 1 μm and at least one dimension of which is between 1 and 1000 μm, this heating element being formed of a ferromagnetic metal compound, under an atmosphere devoid of oxygen,
and, still under said atmosphere devoid of oxygen, heating this heating element by electromagnetic induction via a magnetic field inductor external to the reactor, this heating being carried out at a temperature comprised in said temperature range.

In the present description, external to the reactor means that the magnetic field inductor is not located in the atmosphere of the reactor, in the sense that it is located outside of the reaction zone of the reactor, in which the substrate and the heating element are contacted with one other, under the atmosphere devoid of oxygen. The magnetic field inductor can be placed so as to surround the reactor or so as to be contained in the reactor (for a reactor of the annular type for example), as long as it remains external to the internal atmosphere of said reactor.

In the present description, micrometric form means that the heating element is in the form of an entity/entities all the dimensions of which are greater than or equal to 1 μm and at least one dimension of which is between 1 and 1000 μm.

The heating element implemented in the method according to the invention is formed of at least one, that is to say one or more, ferromagnetic metal compounds.

It can further contain other compounds, which can be inert or not with respect to the transformation reaction to be carried out. In alternative embodiments of the invention, the heating element consists of one or more, preferably just one, ferromagnetic metal compound(s).

A heavy oil is defined in the present description, in a manner conventional per se, as a hydrocarbon or a mixture of hydrocarbons with a high boiling point, comprising at least 12 carbon atoms, such as octadecane. When the substrate is a heavy oil, its transformation according to the invention is aimed at the formation of “lower” hydrocarbon(s), that is to say comprising a much lower number of carbon atoms, in particular a number of carbon atoms between 1 and 4, with a much lower boiling point.

The type of reaction for transforming the substrate into hydrocarbon(s), which the method according to the invention makes it possible to carry out, varies according to the operating conditions implemented, and in particular the atmosphere in the reactor during the heating step. As indicated above, this atmosphere is devoid of oxygen. The atmosphere in the reactor during the heating step can be of the inert type. The reaction of transformation of the substrate, qualified as pyrolysis or thermolysis, is then only caused by the heat. Otherwise, the atmosphere in the reactor during the heating step can be of the reducing type, and in particular contain dihydrogen. In this case, the transformation reaction is a hydrogenolysis, which can be combined with a pyrolysis according to the operating conditions applied. The reaction products obtained at the end of the transformation reaction are different according to the type of reaction, and the mechanism(s) it implements. They are also different according to whether or not the method according to the invention uses, in addition to the micrometric heating element, a catalyst of the transformation reaction. As examples, a reaction of hydrogenolysis of a plastic polymer, in the presence of a catalyst of this reaction, leads to obtaining a mixture of oligomers, alkanes, in particular methane, olefins, and coke, divided into gaseous, liquid and solid phases. A reaction of thermal and/or catalytic pyrolysis, under an inert atmosphere, leads to a mixture of gaseous alkanes, liquid fuels and carbon materials.

The temperature range at which the transformation reaction occurs depends on the type of reaction, and in particular on the atmosphere implemented in the reactor and on whether or not a catalyst of the reaction is present in the latter, as well as on the chemical nature of the substrate. It falls within the skills of the person skilled in the art to be able to determine this temperature range according to the specific substrate to be recycled and the desired reaction products (determining the type of transformation reaction to be implemented, pyrolysis and/or hydrogenolysis, and the choice of the possible catalyst, or of a lack of catalyst). This temperature range is typically comprised in the interval between 30° and 650° C. For any targeted temperature range, it also falls within the skills of the person skilled in the art to be able to determine the operating parameters to be implemented for the application of the magnetic field in the reactor, so as to reach a suitable temperature in the latter, causing the transformation reaction to occur. For the determination of these operating parameters, the person skilled in the art will also take into account the characteristics of the specific heating element used, in particular its specific absorption rate (SAR) and the quantity thereof present in the reactor. SAR is a well-known parameter per se, defining the heating capacity of a magnetic or electrically conductive material subjected to an alternating magnetic field.

In all its embodiments, regardless of the type of transformation reaction, the method according to the invention advantageously enables to obtain, from plastic material or heavy oil, one or more gaseous, that is to say C1-C4, hydrocarbons with high added value, and even more so in the case of methane, which is systematically obtained at the end of the method, with good yield and good selectivity, unlike the methods of the prior art which do not implement micrometer-sized heating elements but implement nanometer- or millimeter-sized heating elements (such as balls). In this respect, the method according to the invention enables in particular, in specific embodiments, to form, from plastic material or heavy oil, methane with high yield, but also with very high selectivity; methane can even, under certain conditions, be the only gaseous product of the reaction. In particular, such selectivity with respect to methane can advantageously, and in a particularly surprising manner, be obtained without implementing any catalyst of the reaction of transformation of the substrate, in the presence of a dihydrogen atmosphere, including using simple iron wool as a heating element. The method according to the invention also leads to obtaining solid reaction product(s), and can lead, according to the operating parameters applied, to obtaining liquid reaction product(s). In specific embodiments of the invention, implementing a specific catalyst of the transformation reaction, such as ruthenium, the method according to the invention can advantageously enable to obtain saturated alkanes with a longer chain than the gaseous hydrocarbons, typically C5-C30, in liquid form, also of high added value.

The method according to the invention is particularly energy-efficient, even when the transformation reaction only involves pyrolysis. In this respect, it benefits from the property of ferromagnetic metal compounds of rising in temperature when they are subjected to an electromagnetic field, under the effect of their own magnetic moment. During the implementation of the heating step of the method according to the invention, only the heating element is heated. Under the effect of the electromagnetic field applied to the reactor, its temperature rises rapidly, locally reaching a temperature comprised in the temperature range at which the transformation reaction according to the invention occurs. As indicated above, it falls within the skills of the person skilled in the art to determine the characteristics of the magnetic field to be applied according to the targeted temperature range (typically, a temperature range comprised in the interval between 30° and 650° C.), as well as the specific ferromagnetic metal compound(s) forming the heating element used according to the invention, and the amount of heating element used. Advantageously, the transformation reaction consequently occurs at the surface of the heating element, without the reaction medium as a whole reaching the temperature necessary for the targeted transformation reaction, including when the substrate is initially in solid form (the local heating at the surface of the heating element having a first effect of inducing the melting of the solid plastic materials in contact with it, resulting in an increase in the surface of contact between the heating element and the liquefied substrate).

The low-energy-consumption nature of the method according to the invention is advantageously proven even in the absence of a reducing atmosphere in the reactor, and in the absence of catalyst. In such configurations, it is particularly inexpensive to implement, due to the low cost of the reagents to be used.

The reactor preferably does not contain any element formed of a ferromagnetic metal compound the size of which is not micrometric.

The micrometric heating element is preferably free in the reactor, in the sense that it is not maintained in a stationary manner therein.

Preferably, the reactor implemented in the method according to the invention is formed of non-ferromagnetic material, for example glass, quartz, silicon carbide or any other non-metallic solid material compatible with exposure to a magnetic field and with the temperatures involved.

The method according to the invention can further have one or more of the features described below, implemented alone or in each of the technically effective combinations thereof.

The substrate that the method according to the invention aims to transform, when it is formed of plastic material(s), can initially be in solid form, in particular in the form of solid fragments, for example fragments of plastic bottles. It is preferably in liquefied form. Thus, the method according to the invention can comprise an initial step of liquefying the substrate, before its introduction into the reactor, or carried out directly in the reactor. Such a step can be carried out by any heating technique conventional per se. As an example, particularly advantageous from the point of view of the ecological footprint of the process, the liquefaction step can be carried out by heating by solar energy. The heating temperature to be applied depends on the specific plastic material to be liquefied, more specifically on its melting temperature, and its determination for each given substrate falls within the skills of the person skilled in the art. Typically, the melting temperature of the plastic materials is between 9° and 200° C.

When it is formed of plastic material(s), the substrate can in particular be formed of polyolefin, such as polyethylene or polypropylene, of a polyolefin-containing copolymer, that is to say a copolymer comprising units of polyolefin, such as polyethylene terephthalate, of polyester, of polystyrene, or of any of their mixtures. Of course, the reaction products in solid form, and where applicable in liquid form, obtained at the end of the implementation of the method according to the invention, depend on the initial plastic material(s) used.

The micrometric heating element can be chosen from powders of particles containing the ferromagnetic metal compound having a size between 1 and 1000 μm, and wires containing the ferromagnetic metal compound having a wire diameter of between 1 and 1000 μm.

Particles having a size between 1 and 1000 μm means that all the dimensions of the particles are between 1 and 1000 μm. Preferably, the particles have a size between 1 and 100 μm, more preferably between 1 and 50 μm, and preferentially between 1 and 10 μm. Each of the particles can be formed of one or several ferromagnetic metal compounds, and contain only this or these compounds, or can contain additional components for example a catalyst of the targeted transformation reaction, such as cobalt, nickel, copper, ruthenium, rhodium, palladium, platinum or any other catalytic compound, or any alloy of one or more of these compounds. Preferably, the heating element is a set of wires each formed of one or more ferromagnetic metal compounds, preferably composed for at least 90% by weight of one or more, preferably a single, ferromagnetic metal compound(s). In particular embodiments of the invention, each of these wires has a wire diameter of between 1 and 1000 μm, preferably between 10 and 1000 μm, more preferably between 20 and 500 μm, preferentially between 50 and 200 μm, and for example between 50 and 100 μm, and a wire length preferably of several centimeters. In preferred embodiments of the invention, the heating element is in the form of wool, that is to say an entanglement of such wires.

The ferromagnetic metal compound implemented in the method according to the invention, or each ferromagnetic metal compound implemented in the method according to the invention, is preferably chosen from those having a magnetic anisotropy less than or equal to 8·10⁴ J·m⁻³, preferably less than or equal to 3·10⁴ J·m⁻³.

Each of these compounds is preferably chosen from iron, cobalt, nickel, and oxides, carbides and/or alloys thereof, as well as amorphized ferromagnetic materials.

In particular embodiments of the invention, the ferromagnetic metal compound is chosen from iron and its alloys, in particular the alloys of iron and carbon, for example of the Fe/Cx type, such as Fe_{2.2}C, Fe₃C, Fe₅C₂, the alloys of iron and cobalt, and the alloys of iron and nickel. Alloys containing at least 50%, preferably at least 80%, by weight of iron are particularly preferred in the context of the invention, in particular in the context of implementing a heating element in the form of wires.

Otherwise, the ferromagnetic metal compound implemented according to the invention can, when it is in powder form, be chosen from the iron oxides, such as magnetite or maghemite, or from the ferromagnetic ceramics containing iron oxide(s).

In particularly preferred embodiments of the invention, the heating element is iron wool, in particular that referred to as “extra fine”, comprising an entanglement of wires composed of at least 90% by weight of iron, and the average wire diameter of which is between 10 and 1000 μm, preferably between 20 and 500 μm, more preferably between 50 and 200 μm, for example between 50 and 100 μm, and the length of wires of which is several centimeters, for example between 1 and 10 cm. Besides forming a heating element with good performance when it is subjected to a magnetic field, iron wool has the advantages of low production cost and long service life. Moreover, it is easily recoverable, in particular separable from the other components in the reactor, and non-polluting.

In specific embodiments of the invention, the magnetic field generated by the magnetic field inductor, for the heating step of the method, has an amplitude of between 1 and 80 mT and a frequency between 30 and 500 kHz.

The amplitude of the magnetic field is preferably between 1 and 50 mT, more preferably between 25 and 40 mT, preferentially between 27 and 40 mT, even more preferentially between 29 and 40 mT, and for example between 29 and 35 mT.

As for the power, it is preferably between 2 and 5 kW, preferably between 2 and 4 kW, and for example between 2.6 and 3.8 kW.

The frequency of the applied magnetic field is preferably between 50 and 400 kHz, more preferably between 100 and 300 kHz.

Such characteristics of the magnetic field advantageously make it possible to bring the heating element according to the invention to a temperature allowing the intended reaction of transformation of the substrate to occur.

As explained above, in specific embodiments of the invention, the atmosphere in the reactor, for the heating step, can be an inert atmosphere, for example an argon atmosphere, preferably at atmospheric pressure. The method according to the invention can then be qualified as a method for pyrolysis, or thermolysis, of the substrate. Such an embodiment results in the production of gaseous hydrocarbons, in particular in the form of a mixture of methane, ethane and propane, and of saturated liquid, in particular C10-C40, hydrocarbons.

In alternative embodiments of the invention, the atmosphere in the reactor, for the heating step, is a reducing atmosphere. This atmosphere can in particular comprise dihydrogen. It preferably consists of dihydrogen. The method according to the invention can then be expressed in terms of a method for hydrogenolysis, optionally coupled with a pyrolysis, of the substrate. The dihydrogen pressure in the reactor is then preferably of at least 3 bar, preferentially at least 5 bar, and for example between 5 and 10 bar. Generally speaking, the higher the dihydrogen pressure in the reactor, the shorter the duration of the heating step necessary for the formation of the intended products.

An implementation of the method under a dihydrogen atmosphere leads in particular to the formation of a larger gaseous fraction of hydrocarbons than when the method is implemented under an inert atmosphere. Furthermore, it advantageously enables to obtain methane with a high yield, as well as better control of the selectivity of the reaction with respect to methane formation, with respect to the other gaseous hydrocarbons likely to be formed from the substrate.

In particular, in the embodiments of the method in which the atmosphere in the reactor contains dihydrogen, this methane yield and this selectivity with respect to methane are all the higher, including when the reaction medium is devoid of catalyst of the transformation reaction, and including when the heating element consists of simple iron wool, when the mass ratio of the heating element with respect to the substrate, in the reactor, is greater than or equal to 0.2. The selectivity with respect to methane, relative to the other gaseous hydrocarbons, is particularly high, and can in particular be 100%, when the heating element/substrate mass ratio is greater than or equal to 0.25, preferably greater than or equal to 0.3, in particular when the reaction medium is devoid of catalyst of the transformation reaction and/or the heating element consists of iron wool, in particular as defined above.

The invention does not however exclude the heating element/substrate mass ratio in the reactor being less than 0.2, the heating step then being preferably carried out in the presence, in the reactor, of a catalyst of the transformation reaction, in contact with the substrate and the heating element.

In general, the greater the quantity of heating element in the reactor, the shorter the duration of the heating step necessary for the formation of the intended products.

In specific embodiments of the invention, a catalytic metal compound, catalyst of the transformation reaction, is contacted, in the reactor, with the substrate and the heating element during the heating step.

Such a catalytic metal compound can be chosen from manganese, cobalt, nickel, copper, zinc, rhodium, ruthenium, palladium, platinum, iridium and/or tin, or any alloy of one or more of these metals.

The mass ratio “catalytic metal compound/ferromagnetic metal compound”, for example “platinum/iron” (Pt/Fe), is then preferably between 0.1 and 2%.

The catalytic metal compound is preferably present in the reactor in solid form. It can be implemented as is, in powder form for example, or be deposited on a solid support, such as a support made of an oxide of silicon, cerium, aluminum, titanium or zirconium, or of an oxide of any mixture thereof. As an example, the catalytic metal compound can be implemented deposited on a support containing silicon oxide and aluminum oxide, such as the product marketed under the name Siralox by the company Sasol.

In specific embodiments of the invention, the catalytic metal compound is platinum, preferably deposited on a solid support, in particular as defined above. Such a feature promotes in particular the production of gaseous hydrocarbon(s) from the substrate, and in particular of methane, in terms of both yield and selectivity.

In alternative embodiments of the invention, the catalyst is ruthenium. Such a catalyst promotes in particular the production of liquid hydrocarbon(s), in particular saturated, from the substrate.

Still alternatively, the reactor can be devoid of a catalytic compound, in particular a catalytic metal compound, capable of catalyzing the reaction of transformation, by hydrogenolysis and/or pyrolysis, of the substrate into hydrocarbon(s). Preferably, no solid or liquid component other than one or more substrate(s) and one or more heating element(s), as defined above, is introduced, and therefore initially present, in the reactor at the time the heating step is started. Such a feature does not exclude that a compound that is a catalyst of the reaction forms spontaneously in the reactor during the heating step, in particular from the ferromagnetic metal compound(s) forming the heating element.

The absence of a catalytic compound in the reactor during the heating step advantageously induces, in particular when the heating element is iron wool, the formation of gaseous hydrocarbons, to the detriment of the formation of liquid hydrocarbons, and mainly, or even only, of methane.

The method according to the invention preferably comprises a final step of recovering the gaseous fraction contained in the reactor, and where applicable the liquid fraction that can also be contained therein, after a determined time of implementation of the heating step (that is to say, a reaction time). These fractions are advantageously rich in hydrocarbon(s) with high added value, which can be put to good use in numerous fields. The method can also comprise a step of recovering the solid fraction contained in the reactor at the end of the heating step.

The duration of the heating step is preferably greater than or equal to 2 hours, preferably greater than or equal to 5 hours, for example between 2 and 15 hours, preferably between 5 and 15 hours. It is within the skills of the person skilled in the art to determine this duration according to the specific characteristics of the substrate, of the applied magnetic field, of the heating element(s) and where applicable of the catalytic metal compound(s) used.

Another aspect of the invention relates to the use of an element, called heating element, that is micrometric, that is to say in the form of an entity/entities all the dimensions of which are greater than or equal to 1 μm and at least one dimension of which is between 1 and 1000 μm, formed of one or more ferromagnetic metal compound(s), to transform into hydrocarbon(s), by heating of this heating element by electromagnetic induction, a solid or liquid substrate chosen from the substrates formed of plastic material(s) and the heavy oils.

This use can satisfy one or more of the features described above in reference to the method according to the invention.

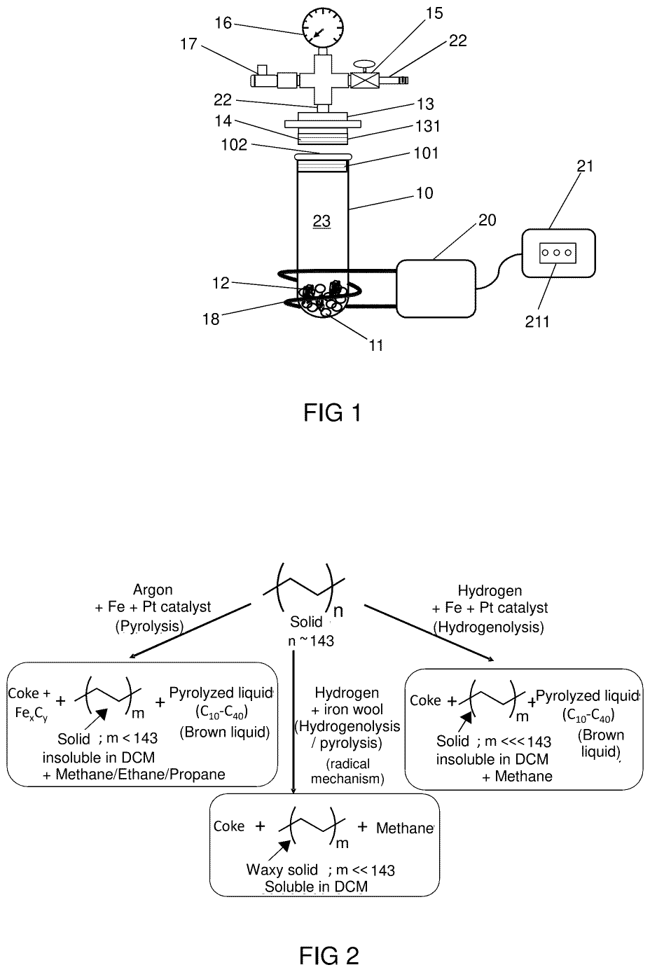

The features and advantages of the invention will be clearer in light of the exemplary embodiments below, provided for illustrative purposes only and in no way limiting to the invention, with the support of FIGS. 1 to 4, in which:

FIG. 1 schematically shows an examplary device for the implementation of a method according to the invention.

FIG. 2 shows examples of transformation reactions that can be carried out by a method according to the invention, starting from polyethylene.

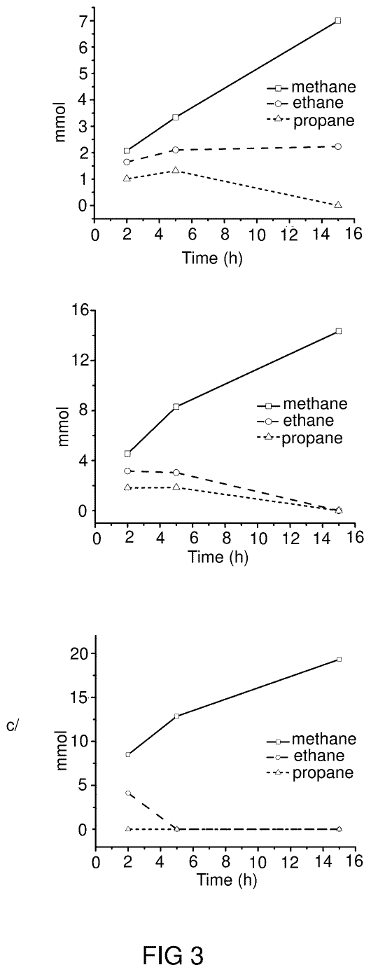

FIG. 3 shows graphs representing, as a function of the reaction time, the respective concentrations of methane, ethane and propane obtained in the gaseous phase formed at the end of the implementation of a method according to the invention for transforming low-density polyethylene, by magnetic induction at 29.3 mT, in the presence of iron wool (100 mg for 500 mg of polymer) and a platinum catalyst supported on Siralox, and in a/ an argon atmosphere at atmospheric pressure, in b/ an atmosphere of 3 bar of H₂, and in c/ an atmosphere of 5 bar of H₂.

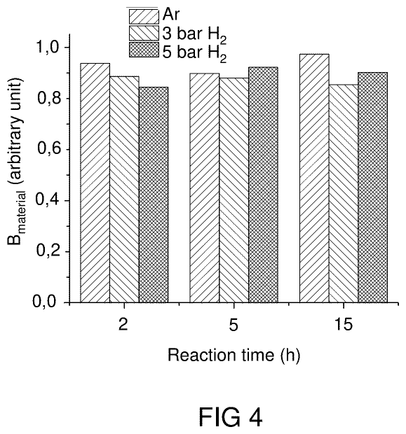

FIG. 4 shows a bar graph representing, for various reaction times, the mass balance Bₘₐₜₑᵣᵢₐₗ (sum of the masses of the gaseous, liquid and solid fractions obtained at the end of the reaction, divided by the initial mass of polymer) at the end of the implementation of a method according to the invention for transforming low-density polyethylene, by magnetic induction at 29.3 mT, in the presence of iron wool (100 mg for 500 mg of polymer) and a platinum catalyst supported on Siralox, and an atmosphere of argon at atmospheric pressure, of 3 bar of H₂ or of 5 bar of H₂.

An example of a device for implementing a method according to the invention is shown schematically in FIG. 1.

It comprises a reactor 10, formed of non-ferromagnetic material, for example from glass, silicon, quartz or silicon carbide. It is in the form of a Fischer-Porter bottle (FP) in the exemplary embodiment shown in the figure.

The substrate to be transformed, in solid or liquid form (solid fragments 11 in the exemplary embodiment shown in the figure), as well as a micrometric heating element 12 formed of a ferromagnetic metal compound, are placed in this reactor 10. In the exemplary embodiment shown in the figure, the heating element 12 is in the form of iron wool pressed into a ball. A catalytic compound that is a catalyst of the reaction of transformation of the substrate into hydrocarbon(s) (not shown in the figure) can also be placed in the reactor 10.

An annular connector 13 is fastened, in a manner sealed off to fluids, to the reactor 10, at the opening 102 of the latter. The fastening is for example carried out by screwing cooperating screw threads 101, 131 respectively carried by the reactor 10 and the connector 13. The sealing of the fastening can be ensured by any means, for example by a sealing washer 14 disposed in the screw thread 131 of the connector 13.

The connector 13 is hydraulically connected to a pipe 22, making it possible to introduce the desired gas into the reactor 10, or to extract a gaseous fraction therefrom. This pipe 22 is for example equipped with an opening/closing valve 15, a pressure gauge 16 and a safety bypass 17, closed during normal operation of the reactor.

The reactor 10 is placed in an electromagnetic induction coil, also called magnetic field inductor, 18. This is preferably a water-cooled coil capable of generating an alternating magnetic field (AMF), for example with a frequency of 300 kHz.

The electromagnetic induction coil 18 is connected to a generator 20, which is controlled by a control module 21, provided with a user interface 211, allowing to control and adjust the operating parameters, and in particular the percentage of the maximum amplitude of the magnetic field. For the electromagnetic induction coil having a frequency of 300 kHz used for the examples described below, the relationship between percentage of the maximum magnetic field applied, power in kW and amplitude of magnetic field applied in mT is indicated in Table 1.

TABLE 1
Characteristics of the magnetic field that can be applied by the
electromagnetic induction coil implemented in the examples

| Percentage of the maximum | | Amplitude of the |
|---|---|---|
| magnetic field applied (%) | Power (kW) | magnetic field (mT) |
| 5 | 0.8 | 17.5 |
| 9 | 1.4 | 22.2 |
| 15 | 2.2 | 27.4 |
| 18 | 2.6 | 29.3 |
| 20 | 2.8 | 30.6 |
| 25 | 3.5 | 33.8 |
| 27 | 3.8 | 35 |
| 30 | 4.2 | 36.6 |

For the implementation of a method according to the invention, the substrate 11 to be transformed (plastic material in liquid or solid form or heavy oil), the heating element 12 and, optionally, the catalytic compound that is a catalyst of the reaction, are placed in the reactor 10. After fastening of the connector 13, the desired gas, for example dihydrogen or argon, is introduced, from the pipe 22, into the reactor 10, at the desired pressure, so as to form in the reactor an an oxygen-free atmosphere 23. The electromagnetic induction coil 18 is then activated for the desired time to carry out the transformation of the substrate into hydrocarbon(s). At the end of this reaction of transformation of the substrate, the gaseous fraction formed, which can be particularly rich in methane according to the operating conditions applied, can be recovered via the pipe 22.

FIG. 2 shows examples of transformation reactions that can be carried out by a method according to the invention starting from polyethylene, having the formula (I):

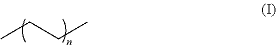

in which, for these examples, n is approximately equal to 143,
and implementing either platinum as a catalyst or no catalyst.

These transformation reactions, corresponding to the various examples that will be described below, lead to various products depending on the operating conditions applied: inert (argon) or reducing (hydrogen) atmosphere, and presence or not of a catalyst (for example platinum, “Pt catalyst” in the figure). As visible in this figure, for each type of reaction, hydrogenolysis and/or pyrolysis, the following are obtained:
according to the conditions, a liquid fraction, in the form of a pyrolyzed brown liquid, formed of about C10-C40 hydrocarbon compounds;
a gaseous fraction, composed, according to the operating conditions implemented, of methane alone, or of a mixture mainly consisting of methane, ethane and propane;
and a solid fraction, formed of coke, where applicable FeₓC_{y} iron carbide (non-stoichiometric carbide probably composed of Fe₃C, Fe₅C₂ and Fe_{2.2}C), possibly amorphous carbides having the formula Feₓ with x between 0 and 1, in particular between 0 and 0.5, and compound(s) having the formula (II):

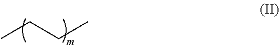

wherein, according to the reaction, m can be:
very much less than 143 (“m<<<143”) (compounds insoluble in dichloromethane (DCM)),
much less than 143 (“m<<143”) (waxy compounds, soluble in DCM),
or less than 143 (“m<143”) (compounds insoluble in DCM).

### EXAMPLES

### A/ General Equipment and Methods

### A.1/ Chemicals and Materials

Tetrahydrofuran (THF, >99%) and toluene (>99%) were provided by Carlo Erba and Fisher Scientific, respectively. The solvents were dried in a solvent purifier (by passing over an alumina-based desiccant) and degassed by argon (Ar) bubbling for 20 min before being transferred and stored in glove boxes. Dichloromethane (DCM) of HPLC quality was supplied by Aldrich and used without additional purification. Siralox (5/320) was obtained from Sasol. Tris(dibenzylideneacetone)diplatinum(0) (Pt₂(dba)₃, >98%) and [Ru(cod)(cot)](cod=1,5-cyclooctadiene; cot=1,3,5-cyclooctatriene) were purchased from NanoMePS.

The iron wool (trade name “Paille de fer FINE”) was obtained from Gerlon and used without additional purification. This iron wool is formed by micro-wires of iron with a diameter of 50 to 100 μm and several centimeters long. Its SAR at 93 kHz and 47 mT is 68 W·g⁻¹. This iron wool was pressed by hand, in order to give it the shape of a small sphere, for all the reactions, with the goal of establishing good contact with the other elements of the mixture.

The following were also obtained from Aldrich:
low-density polyethylene (LDPE), with a low mass average molar mass (M_{w}) (mass average molar mass M_{w} of approximately 4000 g·mol⁻¹; number average molar mass Mₙ of approximately 1700 g·mol⁻¹; melting point 92° C.; in powder form),
LDPE with a high mass average molar mass (melt flow index 25 g/10 min (190° C./2.16 kg); melting point 116° C., in pellet form),
high-density polyethylene HDPE (melt flow index 12 g/10 min (190° C./2.16 kg)),
polypropylene (PP) (isotactic, M_{w} of approximately 12000 g·mol⁻¹; Mₙ of approximately 5000 g·mol⁻¹; melting point 157° C.),
and polystyrene (PS) (M_{w} of approximately 35000 g·mol⁻¹; in powder form).

The plastic bottles made of LDPE of n° 4 quality were purchased from VWR.

All the experiments were carried out with the polymers as received, without additional purification.

### A.2/ Characterization

The powder X-ray diffraction (XRD) patterns were obtained by using a PANalytical Empyrean diffractometer (with cobalt source, having a K_{α} of 1.79 \acute{Å}).

The elemental analysis enabling to quantify the mass content of Pt of the Pt/Siralox and of Ru of the Ru/Siralox was obtained by inductively coupled plasma atomic emission spectroscopy (ICP-AES) on an iCAP 6300 ICP Duo spectrometer.

The scanning electron microscopy (SEM) images were taken on a JEOL JSM-7800F microscope.

The element mapping by scanning electron microscopy coupled with an energy dispersive detection system (SEM-EDX), enabling the identification of the distribution of the elements, was obtained by using a Bruker XFlash® EDX detector attached to the microscope.

The bright-field transmission electron microscopy (TEM) images were obtained on a JEOL JEM 1400 microscope (tungsten filament, operating voltage of 120 kV).

The software ImageJ was used to count the nanoparticles, the size distribution histograms having been obtained on the count of 150 particles.

The high-resolution transmission electron microscopy (HR-STEM) images were recorded on a JEM-ARM200F microscope. The image resolution in STEM mode is 0.78 Å (STEM HAADF 200 kV). The element mapping in STEM in high angle annular dark field (HAADF) mode was carried out to determine the element distribution at the nanometer scale.

The STEM-EDX mapping was obtained by using a CENTURIO-X SDD wide-angle detector (resolution 129 eV) attached to the microscope.

The specific surface area of the samples was obtained by measurement of the isotherms via the Brunauer-Emmett-Teller (BET) method.

The solid residues obtained in the case of the catalytic reactions using Pt/Siralox were characterized by powder XRD, TEM and solid-state cross-polarization magic angle spinning ¹³C nuclear magnetic resonance (CP/MAS ¹³C-NMR).

In the case of the reactions involving iron wool, the black residues obtained in some experiments were characterized by powder XRD and Fourier-transform Raman spectroscopy (FT-Raman).

During the reactions, the apparent temperatures at the surface of the FP bottle were measured and recorded after 10 min of reaction by using a Testo 885 infrared (IR) camera.

### A.3/ Gas Chromatography and Mass Spectrometry

The products in gaseous phase obtained were analyzed and quantified by using a PerkinElmer Clarus® 580 gas chromatograph (GC). The instrument is equipped with a thermal conductivity detector (TCD) for the quantification of the products. In addition, the instrument was connected to a Clarus® SQ-8T mass spectrometer, used for the identification of the products. The initial temperature of the furnace of 80° C. was increased to 250° C. with a ramp of 16° C./min, then maintained for 30 min at 250° C. The injection temperature was set to 200° C. and the carrier gas (helium He) flow rate in the column was set to 1.8 mL/min. A column of the Shin Carbon (ST 80/100) type was used (length 2 m; internal diameter 0.53 mm). The retention times under these conditions for the various compounds likely to be obtained at the end of the reactions are the following: methane 1.82 min; ethylene 5.82 min; ethane 6.66 min; propene 12.51 min; propane 13.39 min; butene 30 min; n-butane 33 min.

### B/ Synthesis of the Supported Catalysts

### B.1/ Synthesis of the Pt/Siralox Supported Catalyst

The platinum (Pt) catalyst supported on SIRALOX was synthesized via decomposition of an organometallic precursor. To this end, 56.8 mg of Pt₂(dba)₃ were mixed with 2 g of SIRALOX support (silicon and aluminum oxide from the company Sasol) in a Fischer-Porter (FP) bottle, followed by the addition of 20 mL of THF. The deep purple suspension was stirred for 15 h. Then, the FP bottle was charged to 3 bar with H₂ and stirred vigorously for 24 h at room temperature. Instantly, the deep purple solution turned dark brown. After 24 h of stirring, the FP bottle was transferred to a glove box, where the residual pressure was released. After 1 h a precipitate formed, the colorless supernatant was separated and the gray solid recovered, to be finally washed by 3×5 mL of toluene. The solid obtained was dried under vacuum for 4 h then transferred and stored in a glove box. The product obtained is called Pt/Siralox.

The analysis by ICP-AES showed a mass content of Pt of 0.78%.

### B.2/ Synthesis of the Ru/Siralox Supported Catalyst

The ruthenium (Ru) catalyst supported on Siralox was synthesized by decomposition of an organometallic precursor, [Ru(cod)(cot)]. The target Ru content in the sample was 5% by weight. 328.5 mg of [Ru(cod)(cot)] were mixed with 2 g of Siralox support in a Fischer-Porter (FP) bottle, followed by the addition of 20 mL of tetrahydrofuran (THF). The deep yellow suspension was stirred for 15 h. Then, the FP bottle was charged to 3 bar with dihydrogen H₂ and stirred vigorously for 24 h at room temperature. Instantly, the deep yellow solution turned dark brown. After 24 h of stirring, the FP bottle was transferred to a glove box, where the residual pressure was released. After 1 h, a precipitate formed, the colorless supernatant was separated and the gray solid recovered to be finally washed by 4×10 mL of toluene. The solid obtained, called Ru/Siralox, was dried under vacuum for 4 h then transferred and stored in a glove box.

The analysis by ICP-AES showed a mass concentration of Ru of 4.49%.

The scanning electron microscopy (SEM) images confirmed the obtention of ruthenium nanoparticles having a small size (diameter d=2+/−0.42 nm) homogeneously dispersed on the Siralox support.

### C/ Example 1—Transformation of the LDPE in the Presence of Iron Wool and Pt/Siralox Catalyst

These experiments were carried out using the LDPE having a low M_{w}.

All the catalytic reactions were carried out in a device as described above, with FP bottles as reactors.

The following were introduced into each FP bottle, in glove boxes:
200 mg Pt/Siralox,
500 mg low-M_{w} LDPE,
as well as, as a heating element 12, 100, 200 or 300 mg of the “Paille de fer FINE” iron wool.

The atmosphere of the FP bottle was evacuated and replaced with either dihydrogen H₂, at a pressure of 3, 5 or 10 bar, or argon, at atmospheric pressure. Then, the FP bottle was placed in the center of the magnetic induction coil capable of generating an alternating magnetic field (AMF) with a frequency of 300 kHz, with a maximum field amplitude of 65 mT.

The catalytic reactions were carried out at 9, 18, or 27% of the maximum amplitude of the magnetic field, and for various reaction times (2 h, 5 h and 15 h).

After switching on the magnetic induction coil, the polymer melted in several minutes, and the release of a white/grayish smoke was observed. The release of smoke decreased strongly with the reaction time until it disappeared. The melting of the polymer, the release of smoke and its gradual stopping depend on many factors, like the ratio mass of polymer/mass of iron wool, the amount of iron wool, the intensity of the applied magnetic field, etc.

The temperature of the outer surface of the wall of the FP bottle was measured by IR camera, at a value of 180 to 280° C. according to the operating conditions.

After completion of the reaction, the FP bottle was allowed to cool and, after it reached ambient temperature, the FP bottle was connected to a device for injection towards the gas chromatograph, allowing the normalized injection at 1 bar of the gaseous phase contained in the FP bottle, for analysis and quantification of the products formed by GC-MS. The residual gaseous phase was evacuated and the dark brown/black residue at the bottom of the FP bottle was washed by 3×5 mL of DCM. The solid residue was filtered then dried overnight while the liquid residue was collected after evaporation of the DCM.

Each reaction was repeated twice in order to ensure the reproducibility of the experimental results.

The mass balance was calculated by counting the mass of each fraction obtained at the end of the reaction (solid, liquid and gaseous fractions) weighted by the initial mass of polymer, according to Equation 1:

$${B}_{material} = \frac{{M}_{solid} + {M}_{liquid} + {M}_{gas}}{{M}_{polymer}} \qquad ( Equation 1 )$$

where Bₘₐₜₑᵣᵢₐₗ is the mass balance (arbitrary unit), M_{solid} is the mass of solid fraction obtained (g), M_{liquid} is the mass of liquid fraction obtained (g), M_{gas} is the mass of gas fraction obtained (g) and M_{polymer} is the initial mass of polymer (g).

The yield (%) of methane (noted as Y_{CH4}) was calculated by taking into account the total amount of polymer used for each reaction, according to Equation 2:

$${Y}_{CH 4} = \frac{{mmol}_{CH 4} \times {PM}_{CH 4}}{{M}_{polymer}} \times 100 \qquad ( Equation 2 )$$

where Y_{CH4} is the methane yield of the reaction, mol_{CH4} is the number of moles of methane obtained at the end of the reaction measured by GC-MS, PM_{CH4} is the molecular weight of the methane (g/mol) and M_{polymer} is the initial mass of polymer (g).

The optimization of the catalytic transformations of the low-M_{w} LDPE in the presence of the Pt/Siralox catalyst was thus carried out by evaluating the effect, as indicated above: of the reaction time (2, 5 and 15 h), of the composition of the initial atmosphere (argon or dihydrogen), of the pressure of the initial gaseous phase (3, 5 and 10 bar of H₂, or argon at atmospheric pressure), of the % of the maximum magnetic field amplitude applied (9, 18 and 27%), which is respectively equivalent to a magnetic field amplitude of 22.2, 29.3 and 35 mT, and to a power of 1.4, 2.6 and 3.8 kW), and of the amount of iron wool used (100, 200 and 300 mg).

The gas phase obtained at the end of each reaction was analyzed by GC-MS, and its respective contents in methane, ethane and propane were determined. The results obtained are illustrated in FIG. 3, in a/ for the argon atmosphere, in b/ for the atmosphere of 3 bar of H₂ and in c/ for the atmosphere of 5 bar of H₂. As visible in this figure, methane is the product most formed, and its production increases with the reaction time. Under an H₂ atmosphere, the ethane and propane contents decrease with the reaction time, due to their hydrogenolysis. The greater the H₂ pressure in the reactor, the larger the amount of methane produced.

The methane yields obtained for the various atmospheres and the various reaction times, for 100 mg iron wool and 18% field amplitude (29.3 mT), as well as the temperatures of the outer surface of the wall of the FP bottles measured after 10 min of reaction, are indicated in Table 2.

TABLE 2
Methane yields and temperatures measured, under conditions
of 100 mg of iron wool and 18% field amplitude

| Atmosphere | Time (h) | Y_{CH4} (%) | Temperature (° C.) |
|---|---|---|---|
| Argon (Patm) | 2 | 6.6 | 150-160 |
| | 5 | 10.7 | 150-160 |
| | 15 | 22.5 | 160-170 |
| H₂ (3 bar) | 2 | 14.6 | 150-160 |
| | 5 | 26.6 | 155-160 |
| | 15 | 46 | 160-165 |
| H₂ (5 bar) | 2 | 27.2 | 150-155 |
| | 5 | 41.2 | 160-165 |
| | 15 | 61.9 | 160 |

For each of the reactions, the masses of each of the gaseous, liquid and solid fractions formed were measured and the mass balance Bₘₐₜₑᵣᵢₐₗ was calculated according to Equation 1. The results obtained are shown in FIG. 4. As visible, for all the conditions tested, the mass balance is particularly high, between 0.85 and 0.95.

The methane yields obtained for the various % of field amplitude, under 5 bar of H₂, for 100 mg of iron wool and 15 h of reaction, as well as the temperatures of the outer surface of the wall of the FP bottles measured after 10 min of reaction are indicated in Table 3.

TABLE 3
Methane yields and temperatures measured, for conditions
of 5 bar of H₂, 100 mg of iron wool and 15 h of reaction

| | | | |
|---|---|---|---|
| % of field amplitude (%) | 9 | 18 | 27 |
| Y_{CH4} (%) | 19.1 | 62 | 62.3 |
| Temperature (° C.) | 140-150 | 160 | 150-160 |

The methane yield is substantially equivalent for the 18% and 27% of field amplitude, and much higher than that obtained for 9% of field amplitude.

The methane yields obtained for the various initial quantities of iron wool and the various reaction times, for 18% field amplitude and under 5 bar of H₂, as well as the temperatures of the outer surface of the wall of the FP bottles measured after 10 min of reaction are indicated in Table 4.

TABLE 4
Methane yields and temperatures measured, for conditions
of 5 bar of H₂ and 18% of field amplitude

| Quantity of iron wool | Reaction time | Y_{CH4} | Temperature |
|---|---|---|---|
| (mg) | (h) | (%) | (° C.) |
| 100 | 2 | 27.2 | 150-155 |
| | 5 | 41.2 | 160-165 |
| | 15 | 62 | 160 |
| 200 | 2 | 37.3 | 175-180 |
| | 5 | 59 | 170-180 |
| | 15 | 56.3 | 175-180 |
| 300 | 2 | 54.2 | 200-210 |
| | 5 | 55.5 | 200-215 |

Increasing the quantity of iron wool reduces the reaction time required to produce a substantially equivalent quantity of methane. After 2 h of reaction, the greater the amount of iron wool used, the higher the methane selectivity. It is also observed that the higher the temperature of the reactor, the greater the quantity of methane produced in the shortest reaction time.

### D/ Example 2—Transformation of LDPE in the Presence of Iron Wool without Catalyst

Experiments were conducted with iron wool alone, in the absence of Pt/Siralox catalyst, according to a protocol similar to that described in Example 1, applied for:
500 mg or 1 g of low-M_{w} LDPE,
100, 200 or 300 mg of “Paille de fer FINE” iron wool as described above,
a dihydrogen atmosphere at 5 bar of H₂ or argon at atmospheric pressure,
a reaction time of 2, 5 or 15 h,
18% of the maximum amplitude of the magnetic field (29.3 mT, 2.6 kW).

The methane yields obtained for the various initial quantities of iron wool and the various reaction times, as well as the temperatures of the outer surface of the wall of the FP bottles measured after 10 min of reaction and the quantities of methane and ethane obtained at the end of the reaction (propane is not detected), for the initial condition of 500 mg of LDPE, are indicated in Table 5. In this table, the results obtained in Example 1 above, in the presence of the Pt/Siralox catalyst, for the same operating conditions, are also indicated as a comparison.

TABLE 5
Methane yields, quantities of methane and ethane produced,
and temperatures measured, for 0.5 g of LDPE

| Quantity of | Reaction | Methane | Ethane | Y_{CH4} | Temp. |
|---|---|---|---|---|---|
| iron wool (mg) | time (h) | (mmol) | (mmol) | (%) | (° C.) |
| 100 | 2 (Example 1) | 8.48 | 4.12 | 27.2 | 150-155 |
| | 2 | 4.116 | 3.419 | 13.2 | 160 |
| | 5 (Example 1) | 12.857 | 0 | 41.2 | 160-165 |
| | 5 | 5.977 | 3.404 | 19.2 | 160-165 |
| 200 | 2 (Example 1) | 11.614 | 4.419 | 37.3 | 175-180 |
| | 2 | 9.963 | 4.65 | 32 | 220-240 |
| 300 | 2 (Example 1) | 16,881 | 0 | 54.2 | 200-210 |
| | 2 | 14.884 | 0 | 47.7 | 250 |

When the quantity of iron wool is equal to 100 mg, the selectivity with respect to methane and the rate of methane production are lower in the absence of the Pt/Siralox catalyst. In a particularly surprising manner, when the quantity of iron wool used is 200 mg or more (iron wool/initial polymer mass ratio greater than or equal to 0.4), the methane yield and selectivity are substantially similar in the presence or absence of the Pt/Siralox catalyst.

The methane yields obtained for the various initial quantities of iron wool and the various reaction times, as well as the temperatures of the outer surface of the wall of the FP bottles measured after 10 min of reaction and the quantities of methane, ethane/ethylene and propane/propene obtained at the end of the reaction, for the initial condition of 1 g of LDPE, are indicated in Table 6.

TABLE 6
Methane yields, quantities of methane, ethane/ethylene
and propane/propene produced, and temperatures
measured, for the condition of 1 g of LDPE

| Quantity | Reac- | | | | | |
|---|---|---|---|---|---|---|
| of iron | tion | | Ethane / | Propane / | | |
| wool | time | Methane | ethylene | propene | Y_{CH4} | Temp. |
| (mg) | (h) | (mmol) | (mmol) | (mmol) | (%) | (° C.) |
| 100 | 2 | 6.15 | 4.22/0.9 | 1.30/1.8 | 9.9 | 210-220 |
| | 5 | 8.36 | 4.42/1.0 | 1.58/1.8 | 13.4 | 180-200 |
| | 15 | 12.55 | 5.18/0 | 1.87/1.3 | 20.1 | 200-210 |
| 200 | 2 | 10.98 | 6.40/0 | 2.10/1.7 | 17.6 | 200-215 |
| | 5 | 15.64 | 6.80/0 | 3.88/0 | 24.1 | 200-210 |
| | 15 | 32.16 | 7.19/0 | 0 | 51.6 | 220-230 |
| 300 | 2 | 29.05 | 0 | 0 | 46.6 | 265-370 |
| | 5 | 32.35 | 0 | 0 | 51.9 | 250-275 |

It is observed that, for 100 mg of iron wool (iron wool/LDPE mass ratio of 0.1), the methane selectivity and yield are low. For the quantities greater than or equal to 200 mg of iron wool (iron wool/LDPE mass ratio greater than or equal to 0.2), the methane yield is much higher, and comparable to those obtained in the presence of a Pt/Siralox catalyst.

For the quantities greater than or equal to 300 mg of iron wool (iron wool/LDPE mass ratio greater than or equal to 0.3), the selectivity with respect to the formation of methane in the gaseous phase is particularly high.

An additional experiment was carried out with a different, thicker iron wool, formed by micro-wires of iron approximately 300 to 500 μm in diameter, and several centimeters long. The protocol as described above was applied with: 1 g of low-M_{w} LDPE, 300 mg of this iron wool, a dihydrogen atmosphere at 5 bar of H₂, a reaction time of 2 h, 18% of the maximum amplitude of the magnetic field (29.3 mT, 2.6 kW). 27.68 mmol methane were obtained, with a yield of Y_{CH4}=44.4%. This experiment demonstrates that the dimensions of the micro-wires of iron do not change the selectivity of the reaction with respect to methane and the methane yield.

### E/ Example 3—Transformation of LDPE, HPDE and PP Alone or in a Mixture with PS, in the Presence of Iron Wool without Catalyst

The operating protocol described in Example 1 was applied to various plastic materials (low-M_{w} LDPE, high-M_{w} LDPE, HDPE, PP) alone, or to an equal-mass mixture of low-M_{w} LDPE, HDPE, PP and PS, or to 4 to 40 mm² fragments of LDPE bottle, by using 1 g of polymer, mixture or fragments, and 300 mg of “Paille de fer FINE” iron wool as described above, without Pt/Siralox. The FP bottle was charged to a pressure of 5 bar with H₂, then subjected to 18% of the maximum magnetic field amplitude, for 2 h or 5 h.

The results obtained, in terms of quantities of methane, ethane and propane obtained at the end of the reaction, and methane yields obtained, for 2 h of reaction, as well as the temperatures of the outer surface of the wall of the FP bottles measured after 10 min of reaction, are indicated in Table 7.

TABLE 7
Methane yields, quantities of methane, ethane and
propane obtained at the end of the reaction, and
temperatures measured, for 2 h of reaction

| | Methane | Ethane | Propane | Y_{CH4} | Temp. |
|---|---|---|---|---|---|
| Substrate | (mmol) | (mmol) | (mmol) | (%) | (° C.) |
| Low-M_{w} LDPE | 29.04 | 0 | 0 | 46.6 | 265-270 |
| High-M_{w} LDPE | 28.16 | 7.04 | 0 | 45.2 | 240-250 |
| LDPE bottle fragments | 28.43 | 0 | 0 | 45.6 | 240-260 |
| HDPE | 20.08 | 6.92 | 4 | 32.2 | 260-280 |
| PP | 27.01 | 7.25 | 0 | 43.3 | 250-280 |
| Low-M_{w} LDPE + | 27.22 | 7.14 | 0 | 43.7 | 240-260 |
| HDPE + PP + PS | | | | | |

It is observed that high methane yields, as well as good selectivity with respect to the formation of methane, are obtained for all the substrates, including for the mixture “Low-M_{w} LDPE+HDPE+PP+PS”. A similar result is obtained for a “Low-M_{w} LDPE+HDPE+PP+PU” (PU=polyurethane) mixture.

The results obtained, in terms of quantities of methane, ethane and propane obtained at the end of the reaction, methane yields obtained, for 5 h of reaction, as well as the temperatures of the outer surface of the wall of the FP bottles measured after 10 min of reaction, are indicated in Table 8.

TABLE 8
Methane yields, quantities of methane, ethane and
propane obtained at the end of the reaction, and
measured temperatures, for 5 h of reaction

| | Methane | Ethane | Propane | Y_{CH4} | Temp. |
|---|---|---|---|---|---|
| Substrate | (mmol) | (mmol) | (mmol) | (%) | (° C.) |
| Low-M_{w} LDPE | 32.35 | 0 | 0 | 51.9 | 250-275 |
| High-M_{w} LDPE | 31.83 | 7.12 | 0 | 51.1 | 240-250 |
| LDPE bottle fragments | 28.43 | 0 | 0 | 51.6 | 240-260 |
| HDPE | 32.19 | 0 | 0 | 51.6 | 260-280 |
| PP | 33.92 | 0 | 0 | 54.4 | 250-280 |
| Low-M_{w} LDPE + | 29.94 | 0 | 0 | 48.0 | 240-260 |
| HDPE + PP + PS | | | | | |

It is observed that the methane yield increases with the reaction time, as does the methane selectivity, a selectivity of more than 99% methane being observed for all the substrates except for the high-M_{w} LDPE, for which the selectivity of the reaction with respect to methane is nevertheless very high, greater than 80%.

### F/ Example 4—Transformation of LPDE or Octadecane, in the Presence of Iron Wool without Catalyst

The operating protocol described in Example 1 was applied to low-M_{w} LDPE or octadecane (boiling temperature 317° C.), by using 1 g of this substrate and 300 mg of “Paille de fer FINE” iron wool as described above, without Pt/Siralox. The FP bottle was charged to a pressure of 5 bar with H₂, then subjected to 18% of the maximum magnetic field amplitude, for 2 h or 5 h.

The results obtained, in terms of quantities of methane, ethane and propane obtained at the end of the reaction, methane yields obtained, as well as the temperatures of the outer surface of the wall of the FP bottles measured after 10 min of reaction, are indicated in Table 9.

TABLE 9
Methane yields, quantities of methane, ethane and
propane obtained at the end of the reaction, and
measured temperatures, for 2 h or 5 h of reaction

| | Reaction | Methane | Ethane | Propane | Y_{CH4} | Temp. |
|---|---|---|---|---|---|---|
| Substrate | time (h) | (mmol) | (mmol) | (mmol) | (%) | (° C.) |
| LDPE | 2 | 29.05 | 0 | 0 | 46.6 | 265-270 |
| LDPE | 5 | 32.35 | 0 | 0 | 51.9 | 250-275 |
| Octadecane | 2 | 34.60 | 8.4 | 0 | 55.5 | 200-225 |
| Octadecane | 5 | 32.34 | 0 | 0 | 51.9 | 220-240 |

The results are particularly satisfactory for both substrates tested.

### G/ Example 5—Transformation of LDPE in the Presence of Iron Wool without Catalyst, for Various Quantities of Iron Wool

The operating protocol described in Example 1 was applied to low-M_{w} LDPE by using 1 g of this substrate and various quantities of “Paille de fer FINE” iron wool as described above (100, 200, 250, 300 and 350 mg), without Pt/Siralox. The FP bottle was charged to a pressure of 5 bar with H₂, then subjected to 18% of the maximum magnetic field amplitude, for 2 h.

The results obtained, in terms of quantities of methane, ethane and propane obtained at the end of the reaction, methane yields obtained, as well as the temperatures of the outer surface of the wall of the FP bottles measured after 10 min of reaction, are indicated in Table 10.

TABLE 10
Methane yields, quantities of methane, ethane and
propane obtained at the end of the reaction, and
measured temperatures, for 2 h of reaction

| | | Ethane/ | Propane/ | | |
|---|---|---|---|---|---|
| Quantity of iron | Methane | ethylene | propene | Y_{CH4} | Temp. |
| wool (mg) | (mmol) | (mmol) | (mmol) | (%) | (° C.) |
| 100 | 6.15 | 4.22/0.89 | 1.30/1.78 | 9.9 | 210-220 |
| 200 | 10.98 | 6.40/0 | 2.10/1.69 | 17.6 | 200-215 |
| 250 | 26.57 | 7.87/0 | 0 | 42.6 | 220-240 |
| 300 | 29.05 | 0 | 0 | 46.6 | 265-270 |
| 350 | 29.66 | 0 | 0 | 47.6 | 250-285 |

The results, in terms of methane selectivity and yield, are excellent starting from 250 mg of iron wool, that is to say starting from a iron wool/polymer mass ratio of 0.25. The selectivity with respect to methane is particularly high starting from 300 mg of iron wool, that is to say for the iron wool/polymer mass ratios of 0.3 and above.

### H/ Example 6—Transformation of LDPE in the Presence of Iron Wool without Catalyst, for Various Quantities of LDPE

The operating protocol described in Example 1 was applied to low-M_{w} LDPE by using various amounts (500, 1000 and 1500 mg) of this substrate and 300 mg of “Paille de fer FINE” iron wool as described above, without Pt/Siralox. The FP bottle was charged to a pressure of 5 bar with H₂, then subjected to 18% of the maximum magnetic field amplitude, for 2 h or 5 h.

The results obtained, in terms of quantities of methane, ethane and propane obtained at the end of the reaction, methane yields obtained, as well as the temperatures of the outer surface of the wall of the FP bottles recorded after 10 min of reaction, according to the reaction time, are indicated in Table 11.

TABLE 11
Methane yields, quantities of methane, ethane and
propane obtained at the end of the reaction, and
measured temperatures, for 300 mg of iron wool

| Quantity of | Reaction | Methane | Ethane | Propane | Y_{CH4} | Temp. |
|---|---|---|---|---|---|---|
| LDPE (mg) | time (h) | (mmol) | (mmol) | (mmol) | (%) | (° C.) |
| 500 | 2 | 14.88 | 0 | 0 | 47.7 | 250 |
| 1000 | 2 | 29.05 | 0 | 0 | 46.6 | 265-270 |
| 1000 | 5 | 32.35 | 0 | 0 | 51.9 | 250-275 |
| 1500 | 2 | 34.81 | 9.07 | 0 | 37.2 | 220-245 |
| 1500 | 5 | 43.30 | 9.29 | 0 | 46.3 | 230-240 |

The methane yield is excellent for all the quantities of LDPE (iron wool/polymer mass ratios greater than or equal to 0.2). The selectivity with respect to methane is particularly high for 1000 mg of LDPE and less, that is to say for the iron wool/polymer mass ratios greater than or equal to 0.3.

### I/ Example 7—Transformation of LDPE in the Presence of Iron in Various Forms, with Pt/Siralox Catalyst

The operating protocol described in Example 1 was applied to low-M_{w} LDPE (500 mg) and 200 mg of iron, either in the form of “Paille de fer FINE” iron wool as described above, or in the form of nanometric iron powder (average size 0.5 μm, SAR at 93 kHz and 47 mT of 1-10 W·g⁻¹), in the presence of 200 mg of Pt/Siralox. The FP bottle was charged to a pressure of 5 bar with H₂, then subjected to 18% or 100% of the maximum magnetic field amplitude, for 2 h.

The results obtained, in terms of quantities of methane, ethane and propane obtained at the end of the reaction, methane yields obtained, according to the reaction time, as well as the temperatures of the outer surface of the wall of the FP bottles measured after 10 min of reaction, are indicated in Table 12.

TABLE 12
Methane yields, quantities of methane, ethane and propane obtained
at the end of the reaction, and measured temperatures

| | % of | | | | | |
|---|---|---|---|---|---|---|
| | amplitude of | Methane | Ethane | Propane | Y_{CH4} | Temp. |
| Iron | the field | (mmol) | (mmol) | (mmol) | (%) | (° C.) |
| Wool | 18 | 11.61 | 4.42 | 0 | 37.3 | 175-180 |
| Powder | 100 | neg. | 0 | 0 | 0 | 150-200 |

“neg” means “negligible quantity”

The implementation of iron in the form of nanometric powder does not lead to any methane production, contrarily to the micrometric iron wool.

### J/ Example 8—Transformation of the LDPE in the Presence of Iron Wool or Steel Balls

These experiments were carried out by using, as a heating element, iron wool as described above (example according to the invention) or steel balls 2 mm in diameter (example not according to the invention), and the low-M_{w} LDPE.

### J.1/ In the Absence of Catalyst

The operating protocol applied is as described in Example 2 above, with the following parameters:
1 g of low-M_{w} LDPE,
300 mg of “Paille de fer FINE” iron wool as described above, or 0.287 g of steel balls (9 balls),
dihydrogen atmosphere at 5 bar of H₂,
reaction time of 2 h.

For each of the heating elements, the methane yield obtained, as well as the temperature of the outer surface of the wall of the FP bottle measured after 10 min of reaction, and the quantities of methane, ethane/ethylene and propane/propene obtained at the end of the reaction, are indicated in Table 13.

TABLE 13
Methane yields, quantities of methane, ethane/ethylene
and propane/propene produced, and measured temperatures,
for each heating element

| | | Ethane/ | Propane/ | | |
|---|---|---|---|---|---|
| Heating | Methane | ethylene | propene | Y_{CH4} | Temp. |
| element | (mmol) | (mmol) | (mmol) | (%) | (° C.) |
| Iron wool | 29.047 | — | — | 46.6 | 265-270 |
| Steel balls | 5.093 | 6.502/7.129 | 0.395/3.636 | 8.2 | 270-290 |

It is clearly observed that the change in size of the heating element leads to a significant change in the selectivity with respect to methane: a high methane yield is obtained by implementing the micrometric heating element according to the invention, whereas this yield is very low when the heating element has a millimetric size (2 mm in diameter).

### J.2/ In the Presence of the Pt/Siralox Catalyst

The operating protocol applied is as described in Example 1 above, with the following parameters:
0.5 g of low-M_{w} LDPE,
100 mg of “Paille de fer FINE” iron wool as described above, or 96 mg of steel balls (3 balls),
dihydrogen atmosphere at 10 bar of H₂,
reaction time of 15 h.

For each of the heating elements, the methane yield obtained, as well as the temperature of the outer surface of the wall of the FP bottle measured after 10 min of reaction, and the quantities of methane, ethane/ethylene and propane/propene obtained at the end of the reaction are indicated in Table 14.

TABLE 14
Methane yields, quantities of methane, ethane/ethylene
and propane/propene produced, and measured temperatures,
for each heating element

| | | Ethane/ | Propane/ | | |
|---|---|---|---|---|---|
| Heating | Methane | ethylene | propene | Y_{CH4} | Temp. |
| element | (mmol) | (mmol) | (mmol) | (%) | (° C.) |
| Iron wool | 23.982 | — | — | 76.9 | 150-170 |
| Steel balls | 2.6 | Neg. | Neg. | 4.1 | 160-180 |

Neg. indicates a negligible quantity

Here again, a drastic drop in the methane yield is clearly observed when the heating element has a millimetric size (balls 2 mm in diameter), relative to the micrometric shape of the heating element, for which the methane selectivity is particularly high.

### K/ Example 9—Transformation of the LDPE in the Presence of Iron Wool and Ru/Siralox Catalyst

This experiment was carried out by using 500 mg of low-M_{w} LDPE, 40 mg of Ru/Siralox and 100 mg of iron wool. The operating protocol applied was as described in Example 1 above. The experimental parameters applied were more precisely the following: 10 bar of H₂, 18% of the maximum amplitude of the magnetic field, 15 h.

The methane yield thus obtained is 82.6%, and the temperature of the outer of the wall surface of the FP bottle measured after 10 min of reaction is 150-170° C.

What is claimed is:

1. A method for transforming a solid or liquid substrate selected in the group consisting of the substrates formed of plastic material(s) and the heavy oils, into hydrocarbon(s) by a transformation reaction occurring in a given temperature range,
said method comprising steps of:
in a reactor, contacting said substrate and a heating element formed of a ferromagnetic metal compound, under an atmosphere devoid of oxygen,
and heating said heating element by electromagnetic induction via a magnetic field inductor external to said reactor, at a temperature in said temperature range,
said heating element being a micrometric heating element in the form of entity(ies) all the dimensions of which are greater than or equal to 1 μm and at least one dimension of which is between 1 and 1000 μm.

2. The method according to claim 1, wherein said substrate is formed of solid or liquefied plastic material.

3. The method according to claim 1, wherein said substrate is formed of polyolefin, polyolefin-containing copolymer, polystyrene, or any mixture thereof.

4. The method according to claim 1, wherein said heating element is selected from the group consisting of powders of particles containing said ferromagnetic metal compound having a size between 1 and 1000 μm, and wires containing said ferromagnetic metal compound having a wire diameter between 1 and 1000 μm.

5. The method according to claim 1, wherein said ferromagnetic metal compound is selected from the group consisting of ferromagnetic metal compounds having a magnetic anisotropy less than or equal to 8.10⁴ J·m⁻³.

6. The method according to claim 1, wherein said ferromagnetic metal compound is selected from the group consisting of iron and its alloys.

7. The method according to claim 1, wherein the magnetic field generated by said magnetic field inductor has an amplitude between 1 and 80 mT and a frequency between 30 and 500 kHz.

8. The method according to claim 1, wherein the atmosphere in said reactor is an inert atmosphere.

9. The method according to claim 1, wherein the atmosphere in said reactor comprises dihydrogen.

10. The method according to claim 1, wherein the mass ratio of said heating element and said substrate, in said reactor, is greater than or equal to 0.2.

11. The method according to claim 1, wherein a catalytic metal compound that is a catalyst of said transformation reaction is contacted with said substrate and said heating element, in said reactor, during said heating step.

12. The method according to claim 11, wherein said catalytic metal compound is selected from the group consisting of platinum, ruthenium, manganese, cobalt, nickel, copper, zinc, rhodium, palladium, iridium and tin, or is any alloy of one or more of these metals.

13. The method according to claim 12, wherein said catalytic metal compound is platinum, deposited on a solid support.

14. The method according to claim 1, wherein said reactor is devoid of catalytic compound.

15. The method according to claim 1, comprising a final step of recovering the gaseous fraction contained in the reactor.

16. (canceled)
